(19) United States
(12) Patent Application Publication
(10) Pub. No.: US 2011/0217412 A1
(43) Pub. Date: Sep. 8, 2011

(54) CHOLESTEROL LOWERING SUPPLEMENT AND LOW CHOLESTEROL EGG PRODUCED BY USING THE SAME

(75) Inventors: Jeong hak KIM, Jeonju (KR); Hyeon jin KIM, Jeonju (KR); Seong tshool HONG, Jeonju (KR)

(73) Assignee: JINIS BIOPHARMACEUTICALS CO., Jeollabuk-do (KR)

(21) Appl. No.: 13/108,648

(22) Filed: May 16, 2011

Related U.S. Application Data
(63) Continuation-in-part of application No. 11/658,929, filed on Jan. 30, 2007.

(30) Foreign Application Priority Data
Jul. 30, 2004 (KR) 10 2004-0060480

(51) Int. Cl. A23L 1/32; A23D 9/013

(52) U.S. Cl. 426/2; 426/531; 426/614

(57) ABSTRACT

This invention provides compositions and methods for producing low cholesterol poultry eggs using hypocholesterolemic compounds, cholesterol lowering supplements, and feeds therefrom. The compositions include industrial by-products obtained during production of pravastatin as effective ingredients for lowering the cholesterol content in eggs. The present invention enables the production of eggs with greatly reduced cholesterol content in an economical way. Therefore, the present invention can be considered the first technique suitable for practical use in the production of low cholesterol eggs using statins.

### CROSS-REFERENCE TO RELATED APPLICATIONS

This is a continuation-in-part of U.S. patent application Ser. No. 11/658,929 filed Jan. 30, 2007 and which is currently pending, the disclosure of which is incorporated herein by reference.

### TECHNICAL FIELD

This invention relates to compositions and methods for producing low cholesterol poultry eggs using hypocholesterolemic compounds, cholesterol lowering supplements, and feeds therefrom.

### BACKGROUND ART

Cholesterol is a kind of lipid in every animal product. It is an essential constituent of cell membranes in human and serves as a starting material for the synthesis of important biological compounds such as steroid hormones and bile acids. However, it is important to maintain the suggested level of serum cholesterol since exceed amount of cholesterol can be harmful.

Specifically, high serum cholesterol levels are termed hypercholesterolemia (more than 200 mg/dL of blood cholesterol), which is a common chronic disease found in 52% of adults in the world. Hypercholesterolemia is a major risk factor for arteriosclerosis, which leads inter alia to myocardial infarction, angina pectoris, hypertension, and stroke. Currently, coronary artery disease is the leading cause of human mortality in the United States and in many other developed countries although it was the forth cause of death in 1900s. It is generally accepted that high levels of cholesterol in the human diet due to more frequent use of animal products such as eggs, meats, and dairy products (milk and butter) can result in a rise in serum cholesterol and thereby increases the risk of cardiovascular diseases.

However, the consumption of cholesterol-rich animal products increases every year and it seems very difficult to limit the intake of animal products significantly. Therefore, research and development efforts have been directed to low cholesterol foods that can provide both basic nutrition and may prevent coronary heart disease.

Chicken eggs are an excellent foodstuff from a nutritional standpoint due to their composition of high-quality protein, saturated fatty acids, mono- and polyunsaturated fatty acids, minerals, and vitamins. However, in addition to these essential dietary components, eggs contain about 200 mg of cholesterol per egg and have been considered a major source of dietary cholesterol. Because of recent understanding of the association between total plasma cholesterol levels and the incidence of coronary heart disease (CHD), it is surmised that an increased amount of dietary cholesterol may increase risk of CHD (Weggemans et al., 2001). Growing numbers of health-conscious consumers exclude eggs from their diets in an effort to limit daily cholesterol consumption to 300 mg/day as recommended by the American Heart Association (National Institutes of Health Consensus Development Panel, 1985). Hence there has been a steady decrease of per capita egg consumption in developed countries. In the US, increasing public concern over dietary cholesterol is reflected in annual per capita egg consumption, which has declined from 303 to 256 during the past 35 years (US Department of Agriculture, 2002). Eggs with reduced cholesterol content may be an attractive, highly nutritious food for health-conscious consumers and a lucrative product for egg producers. This invention provides compositions and methods for producing low cholesterol poultry eggs using hypocholesterolemic compounds, cholesterol lowering feed supplements, and feeds therefrom.

Statins are cholesterol lowering agents by inhibition of the biosynthesis of cholesterol restraining 3-Hydroxy-3-Methylglutaryl coenzyme A reductase (HMG-CoA reductase). Cholesterol is synthesized by multi-step biosynthesis starting from acetyl-CoA in humans and livestock, warm-blooded animals. The key rate-limiting step in cholesterol biosynthesis is to convert 3-hydroxy-3-methylglutaryl-coenzyme A to mevalonic acid by the key enzyme known as 3-hydroxy-3-methylglutaryl-coenzyme A reductase (HMG-CoA reductase, Formula 1).

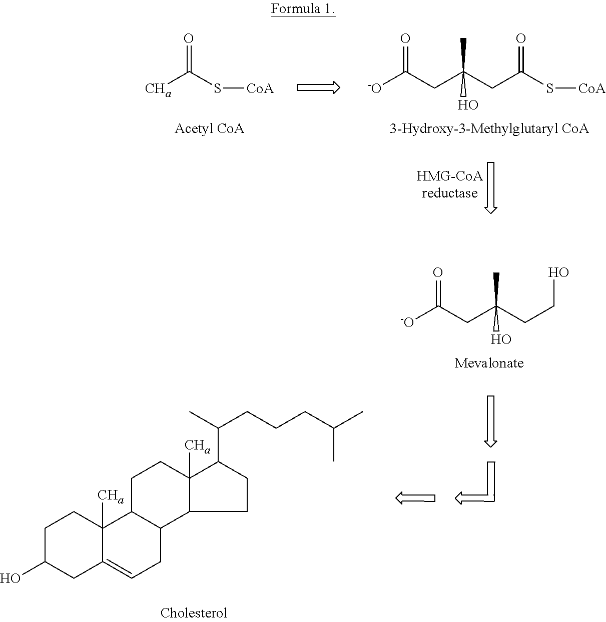

Statin inhibits HMG-CoA reductase due to its structural similarity to mevalonic acid, a substrate of HMG-CoA reductase. Several statins have been developed as cholesterol lowering agents for the treatment of hypercholesterolemia. These include mevastatin (disclosed in U.S. Pat. No. 3,983,140), lovastatin (disclosed in U.S. Pat. No. 4,231,938), pravastatin (disclosed in U.S. Pat. No. 4,346,227), simvastatin (disclosed in U.S. Pat. Nos. 4,444,784 and 4,450,171), fluvastatin (disclosed in U.S. Pat. No. 4,739,073), atorvastatin (disclosed in U.S. Pat. No. 5,273,995), and cerivastatin (disclosed in U.S. Pat. No. 5,502,199).

Among above statins, compactin (mevastatin), lovastatin, and pravastatin are produced by microbial culture while other statins are synthesized. Microbial statins are classified by R group at C[6] as compactin (R:—H), lovastatin (R:—CH₃), and pravastatin (R:—OH). Statins can be lactone structure, acid forms (formula V) or salt.

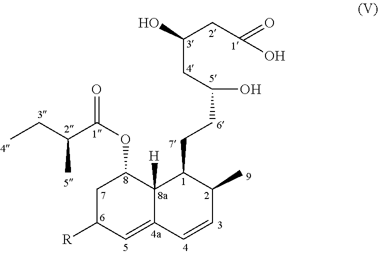

Compactin, having a hydrogen atom in C6 in the formula V, has been isolated in the culture medium of Penicillium (U.S. Pat. No. 3,983,140). Thereafter, several compactin-producing strains were reported in various species, including P. citrinum, P. brevicompactum, P. cyclopium, P. adametzioides, Trichoderma viridae, Aspergillus terreus, Gliocladium sp. (U.S. Pat. Nos. 3,983,140; 4,049,495; 4,137,322; 5,691,173; Korean Pat. No. 832801; 832329; 10-0378640). Unfortunately, the development of compactin as hypocholesterolemic drugs was discontinued after clinical trials showing serious toxicity of compactin. Then, other compounds found to be structurally related to compactin have been isolated and studied for hypocholesterolemic activity. These derivatives are 3-hydroxy compactin, 6-hydroxy compactin, 8a-hydroxy compactin, 4a, 5-dihydrocompactic acid, 5′-phosphocompactic acid, and ML-236A (Chakravarti et al., 2004, Appl. Microbial. Biotechnol. 64:618-624). Japanese Unexamined Patent Publication No. 1979-029772 describes a method for producing eggs with reduced cholesterol content without reduction of egg production using compactin.

Pravastatin, having a hydroxyl group in C6 in the formula V, has been shown to have hypocholesterolemic effect. Unlike compactin, however, pravastatin is not toxic and has been developed as prescription drugs for hypercholesterolemia patients. Currently, pharmaceutical pravastatin is produced by enzymatic bioconversion process in which hydrogen group in C6 of compactin is converted to hydroxyl group by microorganisms (U.S. Pat. No. 4,346,227). In previous arts, several species in the genera of Streptomyces, carbophilus, S. roseochromogenus subsp., Nocardia and Actinomadura were reported to convert compactin to pravastatin by bioconversion process (U.S. Pat. Nos. 5,942,423; 5,179,013; 4,537,859; 4,448,979; 4,346,227; Canadian Pat. No. 1,150,170; 1,186,647; Korean Pat. No. 10-0414334; 10-0180706; Serizawa et al., 1983, J. Antibiotics 36: 887-891).

In previous art of U.S. Pat. No. 6,177,121, it was shown that low cholesterol eggs were produced by administration of purified lovastatin, simvastatin, or atorvastatin (Elkin et al., J. Nutr. 1999:129:1010-1019, Elkin et al., J. Agric. Food Chem. 2003:51:3473-3481). According to this patent, atorvastatin and simvastatin were distinctly effective in the cholesterol content in eggs while lovastatin showed about a 3.9% reduction in cholesterol content, which is negligible in terms of effectiveness, at a dose of 0.03%. Further, feeding 0.03 to 0.06% of atorvastatin or simvastatin for 5 weeks enabled the production of low cholesterol eggs. Unlike lovastatin whose cholesterol lowering effect has proved to be negligible, atorvastatin and simvastatin could be used for the production of low cholesterol eggs. In actuality, however, the production of low cholesterol eggs using atorvastatin and simvastatin has not yet been put to practical use. The reason for this is that the use of atorvastatin and simvastatin as feed supplements increases the production cost of low cholesterol eggs by at least several ten times compared to that of general eggs because these statins are expensive drugs produced by organic synthesis. Another problem is that these statins cause unwanted side effects, such as reduction of egg production, despite their cholesterol lowering effects. From the results in Table 2 of U.S. Pat. No. 6,177,121, it can be seen that atorvastatin, which has proved to be the most effective in lowering the cholesterol content in eggs, caused a 20% reduction egg production than a control group 2, 3 and 4 weeks after administration. Egg production reduction means a decrease in the productivity of eggs and leads to loss of income in poultry farms, which is considered unacceptable by poultry farms. Simvastatin showed about a 10% reduction in cholesterol lowering effect 3 and 4 weeks after administration, which are the periods when reduction in egg production was most serious. These observations lead to the conclusion that the benefits from the use of simvastatin do not exceed its disadvantages. Elkin, et al. reported that these statins lowered the cholesterol content in eggs and caused adverse side effects such as low egg production (┌American Society for Nutritional Science, Robert G. Elkin, et al., 1999, Vol. 129, No. 5, pp. 1010-1019). All the statins described in the U.S. patent issued to Elkin, et al. are substantially unsuitable for the production and commercialization of low cholesterol eggs.

### DISCLOSURE

### Technical Problem

An object of the present invention is to produce eggs with greatly reduced cholesterol content in an economical and commercially viable manner. Many statins proved to be effective in lowering the content of cholesterol in humans exhibit cholesterol lowering effects in animals. However, all of such statins do not lower the content of cholesterol in eggs and the administration of statins proved to be capable of lowering the content of cholesterol in eggs may be accompanied by unwanted side effects such as egg production reduction. A requirement for the use of statins in the production of low cholesterol eggs is that little or no reduction in egg production should be observed as a side effect, and if any, their cholesterol lowering effects should exceed the side effect. Another requirement is that statins should not be expensive, unlike drugs for the treatment of human diseases. The present invention has been made in view of the two requirements, and it is an object of the present invention is to produce low cholesterol eggs using statins in an economical manner and commercially viable manner.

### Technical Solution

The present inventors have continuously conducted research through a series of experiments on various kinds of statins. As a result, the present inventors have found that statins derived from microorganisms cause little or no reduction in egg production, and particularly, statins having a methyl group in C6 in Formula (V) derived from microorganisms can greatly lower the content of cholesterol in eggs without substantially affecting the egg production of hens.

Based on these results, the present inventors have also found that industrial by-products obtained during bioconversion of compactin to pravastatin contain statins capable of meeting the above requirements, i.e. a great reduction in the cholesterol content in eggs and little or no reduction in the egg production of hens. The present invention has been accomplished based on these findings. The bioconversion rate of compactin to pravastatin is commonly as low as 40-70%. Accordingly, the culture broth after convention usually contains pravastatin as well as unused compactin and other compactin derivatives due to incomplete hydroxylation. Streptomyces cell precipitates after removal of broth also contains compactin, pravastatin, and other derivatives in small amounts. Thus, the industrial by-products remaining after separation and purification of pravastatin from the culture broth contain a large amount of compactin and remaining pravastatin and compactin derivatives due to incomplete hydroxylation. Since these statins can meet the above requirements, i.e. a great reduction in the cholesterol content in eggs and little or no reduction in the egg production of hens, the industrial by-products can be used for the production of low cholesterol eggs without further separation and purification of particular statins. As a result, a high production cost of low cholesterol eggs, which is considered the greatest problem associated with the use of statins in feeds, can be solved.

The present invention provides a composition for producing low cholesterol poultry eggs comprising industrial by-products obtained during production of pravastatin as effective ingredients, wherein the pravastatin production involves bioconversion of compactin to pravastatin using microorganisms.

The present invention also provides a feed supplement and a feed for producing low cholesterol eggs comprising the composition.

According to another aspect of the present invention, there is provided a method for producing low cholesterol eggs comprising administrating to poultry industrial by-products obtained during production of pravastatin as effective ingredients, wherein the pravastatin production involves bioconversion of compactin to pravastatin using microorganisms.

According to another aspect of the present invention, there is provided a low cholesterol egg produced by the method.

### BEST MODE

As used herein, the following terms have the following meanings:

“Poultry” is intended to mean any domesticated poultry raised for human consumption, including chicken, quail, duck, goose, ostrich and turkey.

“Egg” is intended to mean any egg products for human consumption from domesticated poultry, including chicken, quail, duck, goose, ostrich and turkey.

“Low cholesterol egg products” is intended to encompass egg products with reduced cholesterol content compared to eggs produced by conventional husbandry methods.

The present invention provides a composition for producing low cholesterol poultry eggs comprising industrial by-products obtained during production of pravastatin as effective ingredients, wherein the pravastatin production involves bioconversion of compactin to pravastatin using microorganisms.

Manufacturing of pravastatin, for example, starts with the culture of C-6 hydroxylation microorganisms, such as Streptomyces. Next, compactin was added into the Streptomyces culture to initiate bioconversion of compactin to pravastatin via C-6 hydroxylation. After bioconversion reaction, the culture broth was recovered by centrifugation of culture for column chromatography to yield pure pravastatin. The culture broth for column chromatography usually contains pravastatin as well as unused compactin and other derivatives due to low conversion rate of about 40-70% and incomplete hydroxylation. Streptomyces cell precipitates after removal of broth also contains compactin, pravastatin, and other derivatives in small amounts. In addition, prewashing solution, washing solution and pass-through during column purification also contains compactin, pravastatin, and other derivatives in small amounts due to incomplete recovery of statin. As such, by-products can be obtained from each step for the production of pravastatin. The industrial by-products can be used as effective ingredients of the composition according to the present invention without further purification. Most of the industrial by-products are in the form of liquids. Preferably, the industrial by-products are dried by heating before use in the composition of the present invention. The term “industrial by-products” as used herein is intended to include all by-products obtained from the overall pravastatin production steps, including the production of pravastatin using microorganisms and the separation and purification of the pravastatin.

Thus, the industrial by-products include at least one of compactin, pravastatin and derivatives thereof.

As used herein, compactin, also called as mevastatin or ML236B, is defined to include lactone structure (formula I), free acid structure (formula II), salt and esters therefrom.

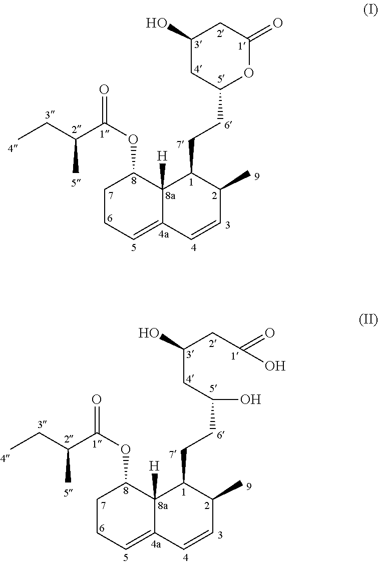

The compactin derivatives are any statins with a hydrogen group in C6 of formula V, including 3-hydroxy compactin, 6-hydroxy compactin, 8a-hydroxy compactin, 4a, 5-dihydrocompactic acid, 5′-phosphocompactic acid, ML-236A. Compactin derivatives are also microbial inhibitors of cholesterol biosynthesis but are not limited thereto. Compactin producing strains include Streptomyces roseochromogenus for 3-hydroxy compactin, Mucor hiemalis for 6-hydroxy compactin, Schizophyllum commune for 8a-hydroxy compactin, Penicillium citrinum for 4a,5-dihydrocompactic acid, Carcinella muscae for 5′-phosphocompactic acid, and Emericella unguis for ML-236A.

As used herein, pravastatin, also called as eptastatin, mezalotin, or pravachol, is defined to include lactone structure (formula III), free acid structure (formula IV), salt and esters therefrom. The pravastatin derivatives are any statins with a hydroxyl group in C6 of formula V.

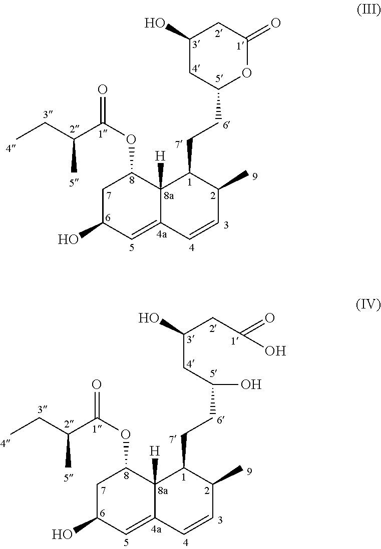

The following Examples Section shows that reduction rates in the production of eggs by compactin, pravastatin and their derivatives having a methyl group (—CH₃) in C6, all of which are statins derived from microorganisms, were at most about 5%, which is negligible compared to those of atorvastatin (U.S. Pat. No. 6,177,121) and simvastatin (U.S. Pat. No. 6,177,121). Particularly, it was found that the industrial by-products containing compactin, pravastatin and their derivatives had little influence to egg production. Meanwhile, the industrial by-products containing compactin, pravastatin and their derivatives greatly lowered the cholesterol content in eggs comparable or superior to atorvastatin (U.S. Pat. No. 6,177,121) known to be the most effective in lowering the cholesterol content in eggs.

In another aspect, the present invention provides a method for producing low cholesterol eggs comprising administrating to poultry industrial by-products obtained during production of pravastatin as effective ingredients, wherein the pravastatin production involves bioconversion of compactin to pravastatin using microorganisms. In another aspect, the present invention provides a low cholesterol egg produced by the method.

The composition may be added to a feed before administration to animals. Preferably, the industrial by-products are added in an amount of 0.01 to 10% by weight to a feed and then the feed is administered at least once daily for at least 5 days. Under these conditions, the composition has a significant effect on the cholesterol level in eggs. Alternatively, the composition may be directly administered. However, the minimum duration and feeding amount to produce low cholesterol eggs can be adjusted depending on the poultry species.

The present invention may be better understood with reference to the accompanying examples that are intended for purposes of illustration only and should not be construed to limit the scope of the invention, as defined by the claims appended hereto.

### Example 1

### Influence of Compactin on the Cholesterol Content in Eggs and Egg Production

(1) Administration of Compactin

Healthy ISA brown hens, 45-week old, were assigned randomly to each dietary group (control group, 8 birds; experimental group, 6 birds each). Each bird was placed in an individual cage in an environmentally controlled room (25° C., 50% relative humidity, 16L:8D). The hens were allowed for 2 weeks in which to adapt to the feed with no additives and the housing. Control birds were fed a commercial diet based on corn and soybean meal (Table 1), while birds in experimental groups were fed diets supplemented with 0.003 or 0.03% of compactin (Sigma Aldrich Korea) for 6 weeks. Feed and water were provided ad libitum throughout the experiment. Feed consumption, egg production and egg weight were recorded daily. Egg production was expressed as percent hen day production; (100×number of eggs laid)/(number of hens×days).

TABLE 1

| Ingredients | % |
|---|---|
| Crude protein (not less than) | 14.50 |
| Crude fat (not less than) | 2.50 |
| Crude fiber (not less than) | 7.00 |
| Crude ash (not less than) | 14.80 |
| Calcium (not less than) | 3.50 |
| Phosphorus (not less than) | 0.35 |
| Methionine and Cysteine (not less than) | 0.50 |
| ME (kcal/kg) | 2,600 |

### (1) Egg Laying Performance

The effects of 0.003% or 0.03% compactin on the laying performance of 45-week old ISA brown hens were investigated (Table 2). Egg weight was maintained at more than 60 grams after 6 weeks of oral administrations of compactin at both doses. Feeding of 0.003% or 0.03% compactin did not cause any difference in egg production compared to the control group without administration of compactin. Maintenance of laying performance with compactin feeding is of contrast to the previous art in which atorvastatin reduced egg production down to 70% after feeding for 5-week.

TABLE 2

| Compactin added | | |
|---|---|---|
| (weight %) | Egg weight (g) | Egg production (%) |
| 0.000 | 66.0 ± 0.5 | 86 |
| 0.003 | 64.2 ± 0.3 | 84 |
| 0.03 | 61.5 ± 0.5 | 81 |

### (3) Egg Cholesterol Analysis

For egg cholesterol analysis, eggs from each bird were collected and egg yolk was separated, weighed, and sampled for analysis. Lipids from eggs were extracted by the method of Folch et al. (1957). Briefly, one gram of sample was saponified with 3 mL of 33% KOH and incubated with 30 mL of 95% methanol in a 65° C. water bath for 90 min. After saponification, 10 mL hexane and 3 mL water were added, followed by vigorous shaking for 10 min. 5α-cholestan (Sigma C-8300) was used as an internal standard. Cholesterol content was determined by a gas chromatography (Shimadzu, Japan) using column VB-1 (30 m×0.25 mm×0.25 μm, VICI Inc.) with a split ratio of 100:1 and nitrogen as carrier gas for a column flow rate of 0.54 mL/min. Injector, column, and detector temperatures were 275° C., 290° C., and 340° C., respectively. Table 3 shows the effect of compactin on egg cholesterol. The average control yolk weight was 17.2 g. Yolk weight showed a slight decrease with compactin administration compared to the control. Administration of compactin caused the significant reduction in yolk weight, compared to the control with 12.8 mg cholesterol per gram of yolk. When expressed as total yolk cholesterol content, percentage changes compared to that of control were 16% and 29% at 0.003% and 0.03% compactin, respectively. It should be noted that low cholesterol egg can be produced by administration of compactin less than 0.03%, indicating compactin is 2 or 3 times more effective than atorvastatin in producing low cholesterol eggs.

TABLE 3

| Compactin | | Cholesterol | Cholesterol | Cholesterol |
|---|---|---|---|---|
| added | Egg York | concentration | content | content change |
| (weight %) | weight (g) | (mg/g) | (mg/egg) | (%) |
| 0.000 | 17.2 ± 0.4 | 12.8 ± 0.1 | 220 | — |
| 0.003 | 16.5 ± 0.4 | 11.2 ± 0.3 | 185 | −16 |
| 0.03 | 14.9 ± 0.7 | 10.5 ± 0.2 | 156 | −29 |

### Example 2

### Influence of Pravastatin on the Cholesterol Content in Eggs and Egg Production

Egg production and yolk cholesterol analysis was performed with 0.003 and 0.03% pravastatin administered group with the same procedure as described in Example 1 above. Hen performance was investigated by measuring egg weight and egg production as in Table 4. Pravastatin group had maintained above 80% of egg production rate after 6-week administration, same as control. This is in contrast with previous art in which atorvastatin resulted in decrease of egg production rate more than 15% compared to control.

TABLE 4

| Pravastatin added | | |
|---|---|---|
| (weight %) | Egg weight (g) | Egg production (%) |
| 0.000 | 66.2 ± 0.5 | 86 |
| 0.003 | 62.5 ± 0.3 | 84 |
| 0.03 | 58.8 ± 0.7 | 82 |

Table 5 shows the effect of pravastatin on egg cholesterol. Administration of pravastatin caused reduction in both yolk weight and cholesterol concentration compared to control, resulting decrease of total cholesterol content. Administration of 0.03% pravastatin produce eggs with 24% less cholesterol compared to control.

TABLE 5

| Pravastatin | Egg york | Cholesterol | Cholesterol | Cholesterol |
|---|---|---|---|---|
| added | weight | concentration | content | content change |
| (weight %) | (%) | (mg/g) | (mg/egg) | (%) |
| 0.000 | 17.2 ± 0.4 | 12.8 ± 0.1 | 220 | — |
| 0.003 | 16.5 ± 0.4 | 12.5 ± 0.5 | 207 | −6 |
| 0.03 | 16.1 ± 0.4 | 10.4 ± 0.5 | 167 | −24 |

### Example 3

### Influence of Industrial By-Products on the Cholesterol Content in Eggs and Egg Production

Streptomyces cell precipitates and cell culture broth after compactin bioconversion were used as cholesterol lowering supplements respectively. First, compactin bioconversion was done as following. Single colony of streptomyces carbophilus was inoculated into 100 ml R2YE in 500 ml erlenmyer flask and incubated at 27° C. at 200 rpm for 3 days. After incubation, 10 ml of seed culture was added to 100 ml of conversion media (glucose 2.0%, corn steep liquor 0.2%, K₂HPO₄ 0.15%, yeast extract 0.1%, MgSO₄.7H₂O 0.15%, ZnSO₄7H₂O 0.001%, NH₄NO₃ 0.1%, peptone 0.1%, pH 7.0) in 500 ml flask and incubated at 27° C. at 200 rpm for 3 days. Then, filter sterilized compactin salt was added into culture up to 0.1% weight of culture and incubated for another 4 days. After bioconversion reaction, culture media was analyzed by TLC to confirm the presence of compactin and pravastatin. This culture was freeze dried for 24 hours and then used as cholesterol lowering supplements. Also Streptomyces cells were obtained from bioconversion reaction by centrifugation at 3,000×g. Streptomyces cell precipitates recovered as pellets was dried at 60° C. and used as cholesterol lowering supplements. Streptomyces cell precipitates as well as bioconversion reaction broth was dried and used as cholesterol lowering supplements as shown in Example 1. Egg production and cholesterol amount were measured afterward.

Egg production and yolk cholesterol analysis was performed with the same procedure as described in Example 1 above except 0.5 and 1% of Streptomyces cell precipitates and bioconversion reaction broth were administered instead of compactin. Hen performance was investigated by measuring egg weight and egg production as in Table 6. Both experimental groups showed usual hen performance similar to control group while egg production rate is marginally increased compared to control.

TABLE 6

| Supplement volume | Egg | Egg |
|---|---|---|
| (weight %) | weight (%) | production (%) |
| Control group | 66.2 ± 0.5 | 85 |
| Dried broth material 0.5 | 63.5 ± 0.8 | 85 |
| Dried broth material 1.0 | 65.1 ± 0.3 | 88 |
| Dried cell material 0.5 | 64.4 ± 0.9 | 87 |
| Dried cell material 1.0 | 64.6 ± 0.7 | 89 |

Table 7 shows the data of egg cholesterol analysis. Egg cholesterol amount as well as yolk weight and cholesterol concentration were reduced in correlation with the amounts of supplements compared to the control. Administration of dried broth material resulted in reduction of egg cholesterol about 17% and 24% in 0.5% and 1% supplement group, respectively. Administration of dried cell material resulted in reduction of egg cholesterol about 13% and 17% in 0.5% and 1% supplement group, respectively.

TABLE 7

| Supplement | Egg york | Cholesterol | Cholesterol | Cholesterol |
|---|---|---|---|---|
| volume | weight | concentration | content | content change |
| (weight %) | (%) | (mg/g) | (mg/egg) | (%) |
| Control | 16.6 ± 0.3 | 12.5 ± 0.1 | 220 | — |
| group | | | | |
| Dried broth | 15.6 ± 0.5 | 11.8 ± 0.5 | 184 | −17 |
| material 0.5 | | | | |
| Dried broth | 15.3 ± 0.2 | 10.9 ± 0.7 | 167 | −24 |
| material 1.0 | | | | |
| Dried cell | 17.0 ± 0.6 | 11.3 ± 0.4 | 192 | −13 |
| material 0.5 | | | | |
| Dried cell | 16.0 ± 0.4 | 11.5 ± 0.9 | 184 | −17 |
| material 1.0 | | | | |

### INDUSTRIAL APPLICABILITY

According to the present invention, the use of industrial by-products obtained during production of pravastatin as effective ingredients greatly lowers the cholesterol content in eggs without reduction of egg production while at the same time solving the problem of a high production cost of low cholesterol eggs associated with the use of statins developed as drugs. The present invention solves the two major problems impeding the practical use of statins for the production of low cholesterol eggs, thus enabling the production of eggs with greatly reduced cholesterol content in an economical manner. Therefore, the present invention can be considered the first technique suitable for practical use in the production of low cholesterol eggs using statins. The present invention enables the production of low cholesterol eggs in a practically feasible way and eventually reduces the intake of cholesterol, thus contributing to the prevention of hypercholesterolemia.

1. A composition for producing low cholesterol poultry eggs comprising industrial by-products obtained during production of pravastatin as effective ingredients, wherein the pravastatin production involves bioconversion of compactin to pravastatin using microorganisms.

2. The composition of claim 1, wherein the industrial by-products are obtained during production of pravastatin using microorganisms, separation of the pravastatin and/or purification of the pravastatin.

3. The composition of claim 1, wherein the industrial by-products include at least one of compactin, pravastatin and derivatives thereof.

4. A feed supplement for producing low cholesterol eggs comprising the composition of claim 1.

5. A feed for producing low cholesterol eggs comprising the composition of claim 1.

6. A method for producing low cholesterol eggs comprising administrating to poultry industrial by-products obtained during production of pravastatin as effective ingredients, wherein the pravastatin production involves bioconversion of compactin to pravastatin using microorganisms.

7. The method of claim 6, wherein the industrial by-products are obtained during production of pravastatin using microorganisms, separation of the pravastatin and/or purification of the pravastatin.

8. The method of claim 6, wherein the industrial by-products include at least one of compactin, pravastatin and derivatives thereof.

9. The method of claim 6, wherein the industrial by-products are added in an amount of 0.01 to 10% by weight to a feed and then the feed is administered at least once daily for at least 5 days.

10. A low cholesterol egg produced by the method of claim 6.
